(19) United States
(12) Patent Application Publication
(10) Pub. No.: US 2018/0341956 A1
(43) Pub. Date: Nov. 29, 2018

(54) Real-Time Web Analytics System and Method

(71) Applicant: Digital River, Inc., Minnetonaks, MN (US)

(72) Inventors: Mark Anthony Everhart, Long Lake, MN (US); James T Paster, Eden Prairie, MN (US); Colin Patrick Clark, Eden Prairie, MN (US)

(21) Appl. No.: 15/631,460

(22) Filed: Jun. 23, 2017

Related U.S. Application Data
(60) Provisional application No. 62/511,366, filed on May 26, 2017.

(51) Int. Cl. G06Q 30/02; G06F 17/30; G06Q 10/06

(52) U.S. Cl. CPC G06Q 30/0201; G06Q 10/06393; G06F 17/30303

(57) ABSTRACT

Implementations of a real-time web analytics platform described herein provide systems and methods for generating operational and business intelligence based on web traffic data and transactional data. Embodiments related to collecting and processing real-time data by using a distributed network to capture and process incoming data streams. Messages are published in a designated message bus queue. Consumer programs pull and store the data in a NoSql database. Each message is immediately added to the previous messages and the individual or aggregated messages may be viewed in real time. Further processing aggregates the data, and metrics are calculated and stored. Comma Separated Value (csv) files are created and loaded into a reporting database for clients viewing longer term (hourly, daily, weekly, monthly) statistics.

### RELATED APPLICATIONS

This application claims the benefit of U.S. Provisional Application No. 62/511,366 filed 25 May 2017, entitled “Real Time Web Analytics System,” which is incorporated herein by reference.

### BACKGROUND

Aspects of the present disclosure relate to web site performance and web transactional data collection, cleansing, aggregation, and analysis to generate business and operational intelligence through real-time analytics.

E-commerce providers hosting web sites, or providing services for web merchants, and web merchants themselves, are interested in finding new ways to attract and keep online customers and protect their systems from data breach and other issues. Intelligence related to web site traffic and customer behavior on a web site can provide key insights into the customer's preferences, determine how application performance affects a customer's behavior and provide early indication of issues that may drive low conversion rates, indicate poor website health or indicate possible fraud. Reporting on data collected during an online user experience is typically time delayed, sometimes making the knowledge that can be gleaned from data outdated by the time a client receives it.

A real-time data feed allows a web merchant to monitor the health of the web site, to monitor flash sales and extensive A/B tests, and to use real time data internally for inventory and fulfillment. Real-user monitoring performed on web sites provides key information regarding the health of a website. A real-time data feed allows the web site administrator to discover and address problems and issues as they are manifested on the site in real-time and take corrective action to minimize cart or web site abandonment, avoid losses due to fraud, prevent application and operational issues, prevent compliance violations and optimize web site content and offers.

The system and method disclosed herein give actionable business and operational intelligence to the client so that they can optimize their customers buying experience and also be able to put hard numbers around the changes that they make. The overall combination of real user monitoring, cart creation and visit details, along with payment processing details allows clients to track over time how changes are not only affecting sales, but the entire shopping experience.

By monitoring the performance of close rates and page performance over time, web platforms can analyze where possible improvements can be made and more importantly have metrics and numbers around the changes they do make, so they can verify and validate their effectiveness. For payment processing systems, it allows risk and compliance to highlight and investigate areas that have possible issues before losses or data issues can occur.

### SUMMARY

Systems and methods providing real-time web analytics are disclosed. One embodiment features data source or client, data processing and analytics devices and workflow, and a data science system. Embodiments of the disclosed system and method provide web and other event-based analytics in real-time. A client may receive a request for an event initiated by a user and publish it to the analytics processing platform. The client may append additional data to the message and transform it into a JSON format prior to publishing the request on a message bus. Raw messages are captured in a real-time data message processing queue, scrubbed based on source data requirements and republished to topic queues in a message bus for further consumption.

The message is extracted from the queue and written to a message database, creating a document record for the message. This raw message data is available for immediate viewing and analysis. Aggregate processing programs copy the message and aggregate the new message with existing message records. Data metrics programs are run on the newly aggregated data and the results are written to an aggregated data database. Comma separated value (.csv) files are created with the updated aggregated data and loaded into a reporting database with a graphical user interface that presents counts, statistics, and graphical representations to interested clients. The system uses components that are optimized for use with large amounts of streaming data over a highly distributed environment and provide results to the client within real-time parameters.

The system components described herein provide a highly flexible and scalable real-time data collection and analysis system providing actionable business and operational intelligence to ecommerce platforms.

### BRIEF DESCRIPTION OF THE DRAWINGS

FIG. 1 provides an overview of one embodiment of the system and workflow of an analytics data processing platform.

FIG. 1A illustrates an exemplary subsystem provided for users to monitor and visualize real time message data.

FIG. 2 illustrates the use of real user monitoring to capture user data.

FIG. 3 illustrates a specific embodiment of the data processing platform which may be used by a global payment processing platform.

FIG. 4 is a screen shot of a credit card authorization monitoring screen available to the global payment processing platform.

FIG. 5 is a screen shot of a monitoring screen illustrating additional statistics available to the global payment processing platform.

FIG. 6 is a screen shot of a real-time web analytics data presentation graphic and data.

FIG. 7 is a screen shot of a bar graph illustrating page loading range in seconds per count of pages accessed.

FIG. 8 is a screen shot of a location map showing the number of pages accessed in particular time zones.

FIG. 9 provides an overview of a preferred embodiment of the method disclosed herein whereby a client is availed of all statistics provided by the system and method.

FIG. 10 provides an overview of a preferred embodiment of the method disclosed herein for providing real time business and operational intelligence data to a client.

### DETAILED DESCRIPTION

Embodiments of the present invention may be described more fully hereinafter with reference to the accompanying drawings, in which some, but not all, embodiments of the invention are shown. The invention may be embodied in many different forms and should not be construed as limited to the embodiments set forth herein; rather, these embodiments are provided so that the disclosure may enable one of ordinary skill in the art to make and use the invention. Like numbers refer to like components or elements throughout the specification and drawings.

Embodiments of the invention are directed to systems and methods for providing real-time web and transaction analytics. According to the systems and methods of the present disclosure, a real-time web analytics system consumes data from a variety of data sources, processing the data through a plurality of applications that may be developed on top of Open Source technology such as Apache™ Kafka, Apache™ Hadoop, MongoDB, HDFS, Hive, Apache™ Spark, and others. These technologies provide an inexpensive, highly performant environment for streaming applications such as a Real-time Web Analytics System and Method.

In this disclosure, the term “client” refers to a source or consumer of the data processed by the disclosed system. A “user” refers to an individual, operating a computing device and initiating the type of events being consumed by the system. For example, a payment processing platform is a client; the individual making an online payment is a user. An ecommerce system hosting web pages is a client; the individual accessing the web pages is a user. “User” may be used synonymously with “customer.” A use case may be developed for each client defining their use of a particular embodiment. Input and output data, system configurations and data aggregation and metrics programs may be client specific.

Embodiments of the present invention are described below with reference to flowchart illustrations and/or block diagrams of methods, apparatus (systems), and computer program products. It may be understood that each block of the flowchart illustrations and/or block diagrams, and/or combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create mechanisms for implementing the functions or acts specified in the flowchart and/or block diagram block or blocks.

Computer program instructions may also be stored in a non-transitory computer-readable memory that can direct a computer or other programmable data processing apparatus to function in a particular manner, such that the instructions stored in the computer readable memory produce an article of manufacture including instruction means which implement the functions or acts specified in the flowchart and/or block diagram block(s).

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

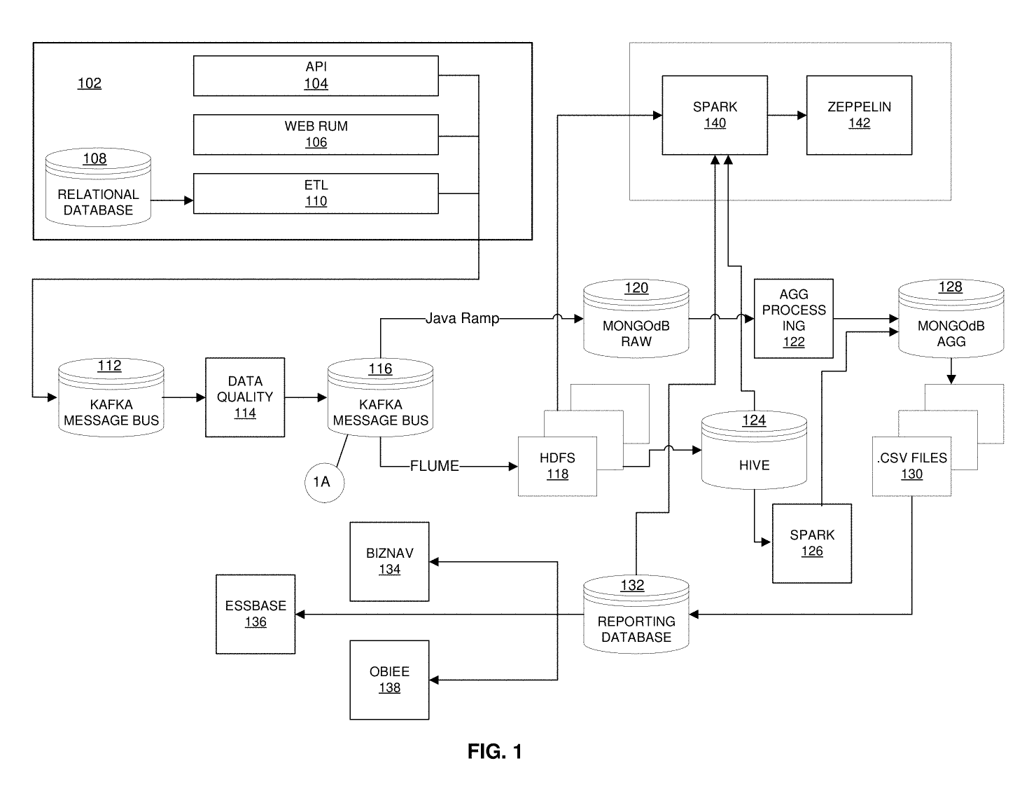

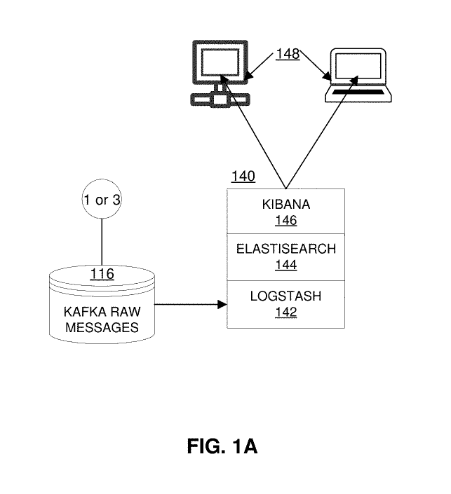

FIG. 1 provides an overview of one embodiment of the system and method workflow of a real-time web analytics data processing platform. This embodiment features data source or client 102 (104-110), data processing and analytics devices and workflow 112-138, and a data science system 140-142. Embodiments of the disclosed system and method provide web and other event-based analytics in real-time. An event may be described as any action taken on the part of a client 102 or a user of the client's system that results in a communication of information between components of a system. A client 102 may receive a request for an event initiated by a user 104, 106, 108 and publish it to the analytics processing platform. For example, an ecommerce provider 104 may receive a requisition transaction via an API, make a copy of the transaction request and publish it to the data processing system at the same time the commerce platform is processing the request. In a preferred embodiment, messages are published and consumed in JSON format. Associated data that is important to understanding the transaction (e.g. source data, bank and other identifiers, etc.) may be appended to the copy prior to publishing the request on a message bus. Raw messages are captured in a real-time data message processing queue, scrubbed based on source data requirements 114 and republished to topic queues in a message bus 116, such as Kafka for further consumption.

As was mentioned above, clients 102 of a real-time web analytics system and method may generate data received by API, typically a REST API 104 where the client may be a payment processing system or ecommerce platform; created by log messages 106 generated from pixel tracking of a user's experience with a web site; or loaded into the system from a database 108, which may use an extract, transform and load tool 110. As a transaction or message is received, it is immediately published to the message bus 112.

Referring again to FIG. 1, the analytics data processing system 112-138 generally comprises at least one computer server for receiving electronic requests from a web-enabled data source, in such forms as a REST API or pixel tracking log data, the server comprising a distributed messaging platform (message bus, or publish-subscribe message system) like Apache™ Kafka 112 which receives messages from multiple client systems 102. In some instances, many server clusters may be used to accommodate a particular embodiment. For example, a global system may use multiple data centers located throughout the world, with an implementation of the web analytics data processing system local to each data center.

Apache Kafka™ is an open source distributed streaming platform/message bus that is implemented in clusters consisting of one or more servers (i.e. Kafka brokers) running an instance of Kafka. Zookeeper maintains meta data about the broker, topics (queues) within the broker, partitions within topics, clients, and other information required to run Kafka. Producers, or publishers, publish JSON messages to designated topics or queues, where they are pulled by consumers. In a preferred embodiment of this disclosure, data source clients are producers, as is data quality and any process that writes message data that will be subsequently pulled by another process. Topics or queues, are provided for raw messages and data quality messages that have updated the raw message. Consumers pull messages using nextMessage, each consumer having been assigned a number of partitions on a particular queue. Consumers in a preferred embodiment include data quality, ramps, and flume which pull the messages using a nextMessage class from assigned partitions, giving the system its scalability.

Data quality processing framework modules 114 comprising program code and stored in server memory, define input-output message parameters and filters for the message bus 112. Input-output parameters direct messages to a particular queue or storage location (or topic, in Kafka) so it available for future consumption. Filters may enhance a message by providing rules regarding data to append to a certain type of message, data cleansing rules, etc. and allow the system to grab subsets of data to publish back out. Filters may be stacked for serial application. A data quality may include in-memory storage stables that include auxiliary data, including look up tables for data standardization and aggregation and resources such as currency conversion tables. When applying a filter, the data quality processing framework may access an in-memory database or additional modules not shown in FIG. 1, for example, a Geo IP system may be accessed to retrieve source location information on an API message if that data is not stored in memory.

Following processing through the data quality framework module 114, processed messages may be written back to a new queue in the message bus 116 and may be extracted from there by any system that can consume the data. In particular, message data may be extracted by a raw message long term storage data store 120. Raw messages may be extracted from the data store 120 as they come in and are processed by aggregation programs 122 that append the message to previously processed messages and recalculate the reporting statistics.

Illustrated in FIG. 1A, a preferred embodiment provides an ELK (Elastisearch 144, Logstash 142, Kibana 146) open source technology stack 140 for extracting, manipulating and visualizing real time data. In an implementation of this reporting stack, Logstash 142 consumes the events from an appropriate Kafka 116 queue, and sends the events to Elastisearch 144. Elastisearch indexes the data and Kibana 146 reads the indexed events from Elastisearch 144, which makes the data available to clients 148. Kibana 146 provides visualization and presentation capability for very large volumes of data.

Returning to FIG. 1, message data may be transferred to different processes depending on how it will be manipulated, reported, or applied to subsequent processes. For example, message data may be moved to separate data storage systems for both long-term and short-term storage, such as 118 and 120. Document-based data storage 118 may be preferable when dealing with large amounts of data required in very short periods of time. Document or file-based data storage, such as HDFS (Hadoop Distributed File System) 118 or MongoDB 120, may be used for longer term storage. HDFS storage may be created by batch processing transaction records that will not be subsequently changed. External database tables, such as those provided by Hive, 124 provide location data for accessing data from HDFS 118. Raw message data transferred to a MongoDB 120 is intense, writing tremendously large numbers of messages to the database as they stream through the system. Data may be transferred between system components (ex: from Kafka 116 to MongoDB or from Kafka to HDFS) using a service best suited to the type of data storage selected. A preferred embodiment uses Apache Flume, acting as a Kafka consumer, to write data to HDFS, and a java Ramp program acting as a Kafka consumer to transfer data to the MongoDB raw message database.

Raw message data in short term storage is processed through a series of data aggregation processes 122. Each message is extracted and aggregated with the previously processed messages and metrics may be calculated. Aggregated data may then be moved to an aggregated data store such as MongoDB AGG 128. Data stored in HDFS 118 may be processed through a data processing engine such as Apache Spark™ 126 and the resulting aggregated data and metrics may be written to the MongoDB AGG 128 as well.

Comma Separated Value (.csv) files 130 are created from the processed data in MongoDB AGG 128, which may be moved, using an ETL tool such as Informatica, to a relational data base 132, where it may be accessed by web applications with a graphical user interface capable of displaying data statistics and graphics, for example, a home-grown business intelligence interface 134, Hyperion Essbase 136, or Oracle Business Intelligence Enterprise Edition (OBIEE) 138.

A data science system, consisting of tools or modules containing program code for calculating and displaying data for very large numbers of messages across many clusters of computers may also consume this data for added business intelligence. Tools such as Apache Spark 140 and Zeppelin 142 are exemplary tools that may be used for this purpose.

As was mentioned above, data can come from nearly any type of client or source 102, including API transactions from commerce, payment, or other transactional platforms 104, web user monitoring from a website hosting platform 106, and ETL transactions 110 from any database or file source 108. Real user monitoring (RUM) captures web traffic data and stores it in a message log storage tool. In one embodiment, beacon technology is used to collect user monitoring data using event-based tracking. A beacon may be programmed to collect data regarding a type of event, the site ID, the visitor ID, page type, date, first byte, page load and other measurements. The tracking program may be added to any web page.

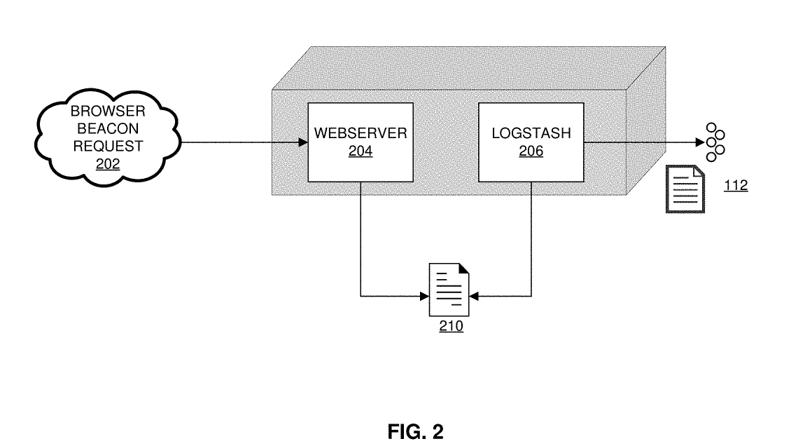

An exemplary event-based web data collection process may use tools such as the open source product Boomerang or similar. Referring to FIG. 2, when an event occurs 202, generally a click on the page or a page element or the loading of a page, the program, typically a java-script beacon, fires, calls the web server 204 and writes the event to the server access log 210. A log collecting, parsing and storage tool such as Logstash 206 reads the log message, transforms it into the type of record that can be read and processed by the message bus, and publishes the message to a pre-defined location in the message bus 112. In a preferred embodiment, messages are json events.

### Data Quality

Referring back to FIG. 1, 114, the data quality (DQ) processing framework modules 114 comprising program code and stored in server memory, define input-output message parameters and filters for the message bus 112. Input-output parameters direct messages to a particular queue or storage location so it available for future consumption. DQ modules are highly available. They can be run on multiple machines in multiple data centers. They are scalable in that a larger number of DQ containers may be run when the system receives a high volume of messages. DQ modules are configurable via configuration files that allow an administrator to configure filters on data streams and configure data streams to message bus queues. The filters, and the filters that are applied to data streams may be modified and deployed quickly. Any number of data quality filters 114 can be applied to a message stream; they may be applied directly—as “stacked” filters, or they may be applied one by one with transformed messages written back to the message bus 112, 116 after each application.

Data quality rules are stored in a highly available in-memory (such as Redis, a product of Redislabs) database in the data quality module, which may be accessed by database and key, and include look up tables for data standardization and aggregation and for resources such as currency conversion tables. Two examples of rules that may be applied are (1) a list of rules used for stripping personal identifying information (PII) from a payment processing transaction and (2) currency conversion from or to USD, given the currency and date. These tables may be updated daily. In a preferred embodiment, data quality filters are written in scala. A filter is a trait in scala, similar to an interface and base class in java. A filter implementation class implements a runFilter function which accepts a string as a parameter and returns a string. Base functionality handles reading and writing the strings from message queues. Multiple filters can be configured for a message stream. This means we can apply many filters on a message that we read from the message bus before publishing it back out. Filters are fault tolerant. If there is an issue, the message will not be lost. Traits (filters) are used to allow multiple ways to ingest or write data, including reading and writing to the Kafka message bus 112, 116. They use the nextMessage class and write as primary function so can easily be adapted to other message buses or even databases.

The data quality framework may provide any number of filters. They are defined and applied based on the type of data that is being collected and the requirements of the client. Table 1 below provides a list of exemplary filters that may be applied to the data source clients described herein. Table 2 provides an example of a geo-enrichment filter written in scala.

TABLE 1
EXEMPLARY DATA QUALITY FILTERS

| FILTER | DESCRIPTION |
|---|---|
| CPGEnrichmentFilter | Converts amounts of requested authorizations to a common |
| | currency |
| CreateCartFilter | Based upon certain values within user agent and other fields we |
| | enrich the data to include things like self-identifying bot, synthetic |
| | testing, etc. |
| CurrencyConverterByDateFilter | Converts currency to a common currency as of the date of the |
| | transaction |
| DRWPCleanPIIFilter | Removes PII data from transactions originating in countries with |
| | restrictions on storing PII date |
| FixSiteIssueFilter | Fixes small issue with siteID coming in with different cases from |
| | the request header (siteID vs SiteID) |
| GCRumFilter | Performs client lookup for a site and enriches the message with |
| | client information. |
| GeoEnrichmentFilter | Determines the originating location of the customer transaction |
| PTClassificationFilter | Has logic to determine the page type for a given RUM message |
| | based upon attributes of the message. Example would be a |
| | thank you page or a product display page |
| RedisCounter | Provides record count in Redis server for auditing/reconciling the |
| | number of records processed |
| RumEnrichmentFilter | Enriches the RUM data with specific data that can be gathered |
| | from the URL, for example locale. |
| TimerEnrichmentFilter | Enriches the data with local date fields which can be used by our |
| | reporting system, which is based upon local date and not UTC. |

TABLE 2
AN EXEMPLARY GEOENRICHMENT FILTER IN SCALA

```
package screen.impl
import scala.io.Source
import com.google.gson._{—}
import org.slf4j.LoggerFactory
import screen.Filter
class GeoEnrichmentFilter extends Filter {
  val logger = LoggerFactory.getLogger(classOf[GeoEnrichmentFilter])
  var master = config.getString(“freegeoip.host”)
  var ip_field = config.getString(“ip_address_field”);
  if (master == null) {
    master = “aquregdev020001.c020.digitalriverws.net:5252”
  }
  if (ip_field == null) {
    ip_field = “client_ip”
  }
  private def getString(inValue: String, jsonBody: JsonObject):String = {
  val value = jsonBody.get(inValue)
    var _value:String = “N/A”
  if (value != null && !value.isJsonNull) {
    _value = value.getAsString
  }
  return _value
  }
  def runFilter(msg: String):String = {
  val json = new JsonParser( )
  val jsonEvent = json.parse(msg).getAsJsonObject
  val jsonHeaders = jsonEvent.getAsJsonObject(“headers”)
  val jsonBody = jsonEvent.getAsJsonObject(“body”)
  val timestamp: Long = System.currentTimeMillis / 1000
  jsonBody.addProperty(“GeoFilterTimestamp”, timestamp)
    var client_ip = getString(ip_field,jsonBody)
    if (client_ip contains “,”) {
            val index_val = client_ip.indexOf(“,”)
            client_ip = client_ip.substring(0,index_val)
    }
    val command = “http://” + master + “/json/” + client_ip
    if (client_ip != “N/A”) {
            try {
                    val geoValues = Source.fromURL(command,
                    “UTF-8”)
                    val geolookup = geoValues.mkString
                    val geoEvent =
                    json.parse(geolookup).getAsJsonObject
                    val country_code = getString(“country_code”,
                    geoEvent)
                    jsonBody.addProperty(“geo_country_code”,
                    country_code);
                    val region_code = getString(“region_code”,
                    geoEvent)
                    jsonBody.addProperty(“geo_region_code”,
                    region_code);
                    val region_name = getString(“region_name”,
                    geoEvent)
                    jsonBody.addProperty(“geo_region_name”,
                    region_name);
                    val city = getString(“city”, geoEvent)
                    jsonBody.addProperty(“geo_city”,city);
                    val zip_code = getString(“zip_code”,
                    geoEvent)
                    jsonBody.addProperty(“geo_zip_code”,
                    zip_code);
                    val latitude = getString(“latitude”, geoEvent)
                    jsonBody.addProperty(“geo_latitude”,latitude);
                    val longitude = getString(“longitude”, geoEvent)
                    jsonBody.addProperty(“geo_longitude”,
                    longitude);
            } catch {
                    case _: Throwable =>
                    logger.error(“Failed call” + command)
            }
    }
  jsonEvent.add(“body”, jsonBody)
  jsonEvent.add(“headers”, jsonHeaders)
  jsonEvent.toString
  }
}
```

### Data Aggregation

As was described above, embodiments of the real-time data analytics system and method may apply a data aggregation module 122 to the raw message/transaction data 120 in order to derive business intelligence 132-138 to monitor the performance of a system or the integrity of incoming transactions. A data aggregation module 122 comprises computer programs, stored in server memory, which when executed by the server processor perform various functions of aggregation and calculation on an incoming message. Data aggregation programs 122 run continuously to append a new, cleansed message to existing aggregating data. Metrics calculation programs create the statistics of interest by performing the desired metrics calculation programs against the data that now includes a new message or messages. Metrics may be calculated for a time period (hour, day, week) for any piece of data collected from the data source. For example, client_id, site_id, locale, page type, user browser type, user operating system, device type, and more. Table 3 below provides some exemplary aggregation and metrics calculation programs that are provided by a preferred embodiment of the disclosed system and methods.

TABLE 3
EXEMPLARY AGGREGATION AND METRICS CALCULATION ROGRAMS

| PROGRAM | TYPE |
|---|---|
| DRWP transaction aggregations | Data Aggregation Method |
| DRWP transaction aggregations on BIN data | Data Aggregation Method |
| Cart aggregations | Data Aggregation Method |
| RUM metrics | Data Aggregation Method |
| metricByClientIdByDay | Metrics Calculation Method |
| metricBySiteByParsedAgentByDay | Metrics Calculation Method |
| metricBySiteIdByBrowserByDay | Metrics Calculation Method |
| metricBySiteIdByDay | Metrics Calculation Method |
| metricBySiteIdByDeviceByDay | Metrics Calculation Method |
| metricBySiteIdByHostnameByDay | Metrics Calculation Method |
| metricBySiteIdByLocaleByBrowserByPageType | Metrics Calculation Method |
| ByPageSubTypeByDay | |
| metricBySiteIdByLocaleByDay | Metrics Calculation Method |
| metricBySiteIdByLocaleByHostnameByDay | Metrics Calculation Method |
| metricBySiteIdByLocaleByHostnameByPageType | Metrics Calculation Method |
| ByPageSubTypeByDay | |
| metricBySiteIdByLocaleByOsByPageTypeByPage | Metrics Calculation Method |
| SubTypeByDay | |
| metricBySiteIdByLocaleByPageTypeByBrowserByDay | Metrics Calculation Method |
| metricBySiteIdByLocaleByPageTypeByDay | Metrics Calculation Method |
| metricBySiteIdByLocaleByPageTypeByHostnameByDay | Metrics Calculation Method |
| metricBySiteIdByLocaleByPageTypeByOsByDay | Metrics Calculation Method |
| metricBySiteIdByLocaleByPageTypeByPageSubTypeByDay | Metrics Calculation Method |
| metricBySiteIdByLocaleByPageTypeByThemeByDay | Metrics Calculation Method |
| metricBySiteIdByLocaleByThemeByDay | Metrics Calculation Method |
| metricBySiteIdByLocaleByThemeByPageTypeBy | Metrics Calculation Method |
| PageSubTypeByDay | |
| metricBySiteIdByOSByBrowserByDay | Metrics Calculation Method |
| metricBySiteIdByOsByDay | Metrics Calculation Method |
| metricBySiteIdByPageTypeByDay | Metrics Calculation Method |
| metricBySiteIdByPageTypeByDeviceByDay | Metrics Calculation Method |
| metricBySiteIdByPageTypeByPageSubTypeByDay | Metrics Calculation Method |
| metricBySiteIdByThemeByDay | Metrics Calculation Method |

Aggregated data and calculated metrics are stored in a database, such as MongodB 128. As each new message flows through the system, creating new aggregated data and new metrics, database records are extracted and .csv files 130 are created from the extracted data. An ETL tool, such as Informatica, may be used to load these records into a relational reporting database 132. Data is presented to a user accessing a graphical user interface of a business intelligence system 138, such as Oracle's Business Intelligence system OBIEE or other interface tools which can access the reporting database.

### Use Case—Payment Processing Platform

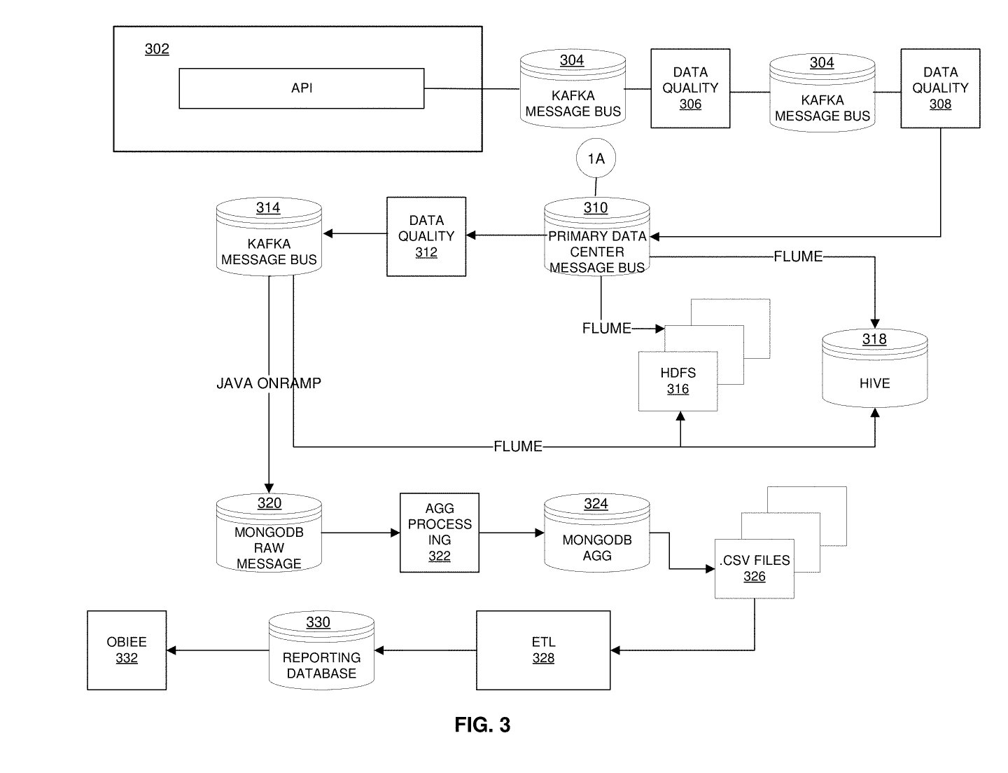

FIG. 3 illustrates an example of a specific embodiment of the streaming real-time web analytics data processing platform. In this example, a high-volume global payment platform 302 requires real-time analytics that may minimize the impact of fraud events by catching and shutting them down before significant losses can occur. In addition to monitoring system performance, the platform may also monitor the integrity of the transactions, e.g., the number of credit card authorizations attempts that fail or succeed. The payment platform 302 may receive data from global locations via application programming interfaces (API) in the form of a request to process a payment. Upon receipt, and while the payment transaction is processing, a copy of the API data is captured and forwarded to a message queuing system in a local data center 304. Alternatively, the platform may forward messages on a batch basis. The payment platform may append data to the message as required. The message may be written to the local server message bus 304, where data quality filters 306 may applied to strip and scrub data according to local laws and monitoring needs. For example, PII (Personal Identifying Information) may be removed from API call data strings for messages originating in Europe to comply with local privacy laws, and the scrubbed message written back to the message bus 304 at the local data center. The de-personalized data may be additionally processed 308 by adding data elements, including master data for relevant reporting and standardization, to convert currency to a standard US value, and to interpret and substitute text (such as abbreviations, etc) to standardize fields for reporting, before being written to a primary global data center message bus 310 to be processed by the data processing system. A data quality “mirror” module transfers this depersonalized and processed data from a European data center to a US data center. Additional data quality modules may apply additional filters 312 to the message data, and republish the message to the US data center message bus 314. As is illustrated in FIG. 1A, Logstash consumes each message upon publication, making real time transaction data available within milliseconds. Clients may access Kibana 146 to view the most current data related to the transaction itself, or to system performance.

Transaction data may be optionally extracted from the primary data center message bus 314 and stored in HDFS 316 and HIVE 318. The transaction message data is further consumed by MongoDB 320 for long term storage and further processing. The message data is extracted from the MongoDB message database 320 and processed through a number of python aggregation jobs 322 which aggregate data and compute statistics, such as those described in Table 3, above. Aggregated and statistical data are stored in a MongoDB AGG datastore. Comma Separated Value (.csv) files are created 326, which are loaded 328 into oracle 330 or reporting/viewing through OBIEE 432. The latest message data received by the system will be in the aggregated statistics within less than a few milliseconds. Aggregated metrics are available the following hour, day, week or month, depending on the granularity of the data.

Tables 4 and 5 below provide some of the metrics that would be of value to a payment processing platform, and some notes on those metrics, respectively.

TABLE 4
EXEMPLARY DASHBOARD SPECIFICATIONS FOR A
PAYMENT PROCESSING PLATFORM APPLICATION

| HEADINGS | GRAIN | FORMULA |
|---|---|---|
| Total¹ CARD Transactions² | Hour/Day/Week/Month | Count (Transactions (pmtype=card&txtype |
| Submitted³ | | in(Authorize,Debit)) |
| (Count) | | |
| Total CARD Transactions | Hour/Day/Week/Month | Sum (Transactions (pmtype=card&txtype |
| Submitted | | in(Authorize,Debit)) |
| (USD Sum) | | |
| Processed CARD Transactions | Hour/Day/Week/Month | Count (Transactions |
| Authorizations⁴ (Count) | | (pmtype=card&txtype=Debit& |
| | | status=Processed,Registered)+ |
| | | Transactions(pmtype=card& |
| | | txtype=Authorize&status=Processed, |
| | | Registered)/ |
| Processed CARD Transactions | Hour/Day/Week/Month | Sum (Transactions (pmtype=card&txtype=Debit& |
| Authorization Amounts (USD Sum) | | status=Processed, Registered)+ |
| | | Transactions(pmtype=card& |
| | | txtype=Authorize&status=Processed, |
| | | Registered)/ |
| Processed CARD Transactions | Hour/Day/Week/Month | Card Auth Rate = |
| Authorizations Rate (Percent) | | Count(Transactions(pmtype=card&txtype=Debit& |
| | | status=Processed, |
| | | Registered)+Transactions(pmtype=card& |
| | | txtype=Authorize&status=Processed, |
| | | Registered)/ |
| | | Count(Transactions(pmtype=card&txtype |
| | | in(Authorize,Debit)) |
| Successful⁵ CARD Transactions | Hour/Day/Week/Month | count (Transactions (pmtype=card&txtype |
| (Count) | | in(Debit,Capture⁶) |
| | | (status=Processed,Registered)) |
| Successful CARD Transactions | Hour/Day/Week/Month | Sum (Transactions (pmtype=card&txtype |
| amount | | in(Debit, |
| (USD Sum) | | Capture) (status=Processed, Registered)) |
| Unsuccessful⁷ CARD Transactions | Hour/Day/Week/Month | count (Transactions (pmtype=card&txtype |
| (Count) | | in(Debit, |
| | | Capture⁸) (status=Decline, System Error)) |
| Unsuccessful CARD Transactions | Hour/Day/Week/Month | Sum (Transactions (pmtype=card&txtype |
| amount | | in(Debit, |
| (USD Sum) | | Capture) (status=Decline, System Error)) |

TABLE 5
NOTES ON PAYMENT PROCESSING
PLATFORM DASHBOARD METRICS

| TERM | MEANING |
|---|---|
| ¹Total | is the accumulation of submitted. Status inclusive of |
| | (Accepted, Processed, Processedbos, Declined, System |
| | Error, Registered |
| ²Transactions | are classified by a combination of multiple fields: |
| | PaymentMethodType, Status and transactionType |
| ³Submitted | includes all transaction authorizations (authorize and |
| | debit) all status (processed, registered, declined, |
| | system error) |
| ⁴Authorizations | (authorize and debit) transaction types (processed, |
| | registered) |
| ⁵Successful | (status processed, registered) |
| ⁶Capture | (successful) (capture and debit) transaction types |
| | (processed, registered) |
| ⁷Unsuccessful | (status decline, system error) |
| ⁸Capture | (unsuccessful) includes both capture and debit |
| | transaction types (declines and system errors) |
| (Authorize, | TransactionType inclusive of (Auth Installment, |
| Debit) | Authorize, Authorize With Ref, Debit, debit With Ref) |
| (Capture, Debit) | Transaction types (Debit, Debit With Ref, Capture) |
| Processed | Status inclusive of (Accepted, Processed, |
| | Processedbos) |

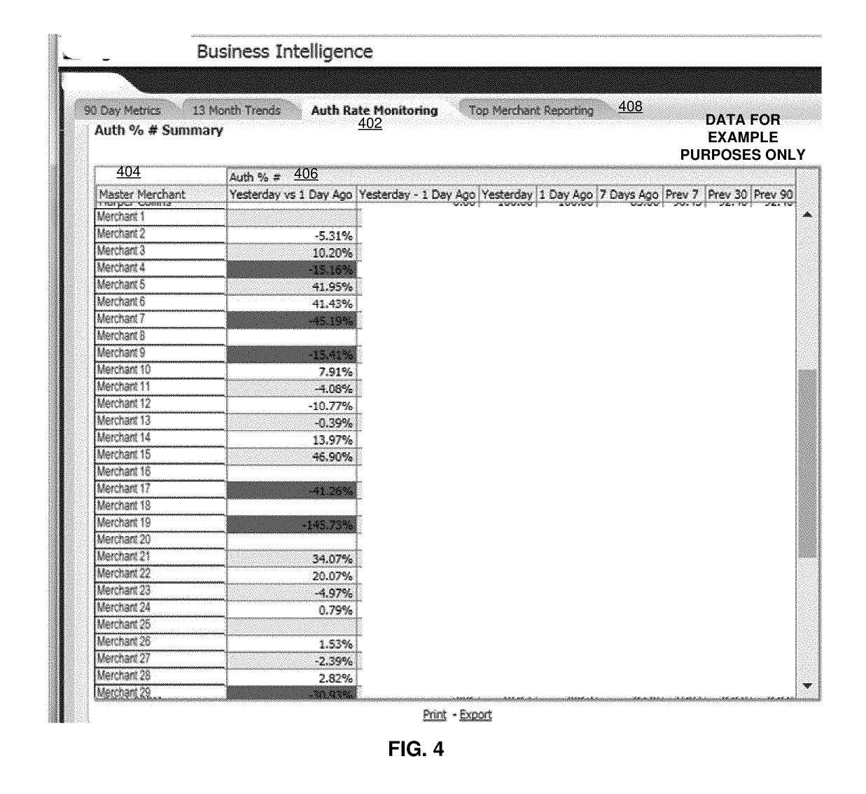

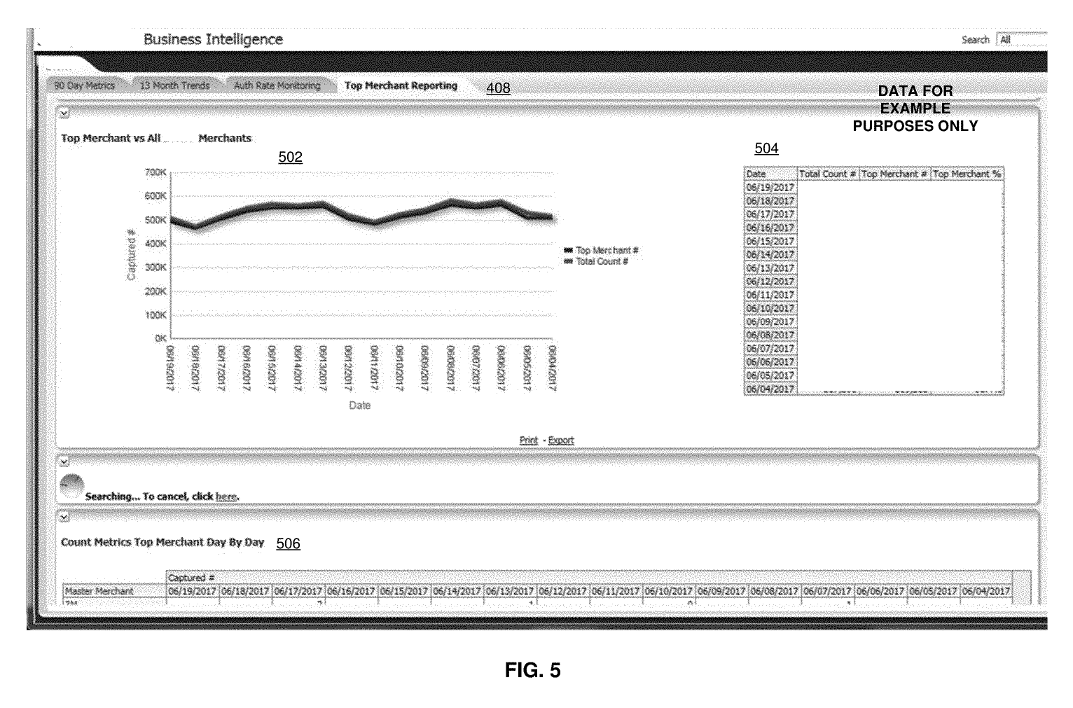

FIGS. 4 and 5 provide exemplary screen shots of the reporting data as viewed in a tool such as a Business Intelligence application. FIG. 4 illustrates an Auth (Authorization) Rate Monitoring tab 402 providing credit card authorization percentages. Master merchants are listed in the left most column 404. Yesterday's authorization percentage vs. 1 day ago is calculated and presented 406. Entries are highlighted when the system indicates that the number is very unusual for the system (please see FIG. 4, Merchants 4, 7, 9, 17, 19 and 29) indicating that further investigation is necessary. Columns are also available for comparing the difference between yesterday and 1 day ago; and daily statistics for Yesterday, 1 day ago, 7 days ago, the aggregate value for the previous 7, 30 and 90 days, respectively. Also provided, but not shown, is a side-by-side tables showing daily detail data for the previous 15 days. Clients may view 90-day metrics, 13-month trends, and Top Merchant 408 reporting as well. FIG. 5 illustrates the Top Merchant 408 report, which graphically displays the number of transactions captured for a defined period compared with the total number of transactions captured from all merchants 502. This data is also presented in tabular form 504. Count metrics for the Top Merchant, Day by Day, are provided in the table below the graphic 506.

### Use Case—Ecommerce Platform

Referring again to FIG. 1, an ecommerce platform may provide events through either Web RUM HTTP event 106 or through a RESTful API event 104 from the commerce system. Data is received and processed as described above. Web merchants and ecommerce platforms are both especially interested in the user experience on the website and relating that data to shopping cart abandonment and conversion. Real User Monitoring collects an enormous amount of data on the user events on a web site. Data collected includes the time of the interaction, data related to the user (e.g. type of device, browser, client accessed by the user, ip address, device operating system, geographical data, sale or no sale, abandon cart, the body of the request, etc.) and data related to the operational performance of each page of the web site (e.g. page load times, responses, etc.).

Clients of an ecommerce system may access the ELK stack 140 for real-time data. Real-time operational performance data provides key insights into the health of the system and allows the ecommerce provider to make adjustments as issues arise, and to associate user behavior with web site performance.

In addition to real-time operational performance data, the ecommerce system may collect information regarding cart creation and visit details from the API 104 requests made from the user to the ecommerce system. In addition to the bounce rate (statistics on the page at which a user leaves) and exit analysis of the RUM data 106, the API request provides data that gives clients an insight into the cart funnel (the customer's path to conversion) which clients have not had access to previously. By analyzing an entire visit which has been captured in a document in the Mongo 120, 128 database, the client can analyze what steps are causing a customer confusion, what elements might be altering the customer's behavior during checkout or signup and what technical nuisances arise during the experience—in other words, the entire customer experience can be analyzed.

By viewing and analyzing this data, clients are able to detect mounting technical problems and take quick action to minimize the impact by analyzing data in real-time. For example, a web store client monitoring page load data found load times quickly deteriorating. Recent changes to the page, indicated that heavy graphics had been added to the web store catalog and loading the page for the particular product was causing customers to abandon the page before it had completed loading.

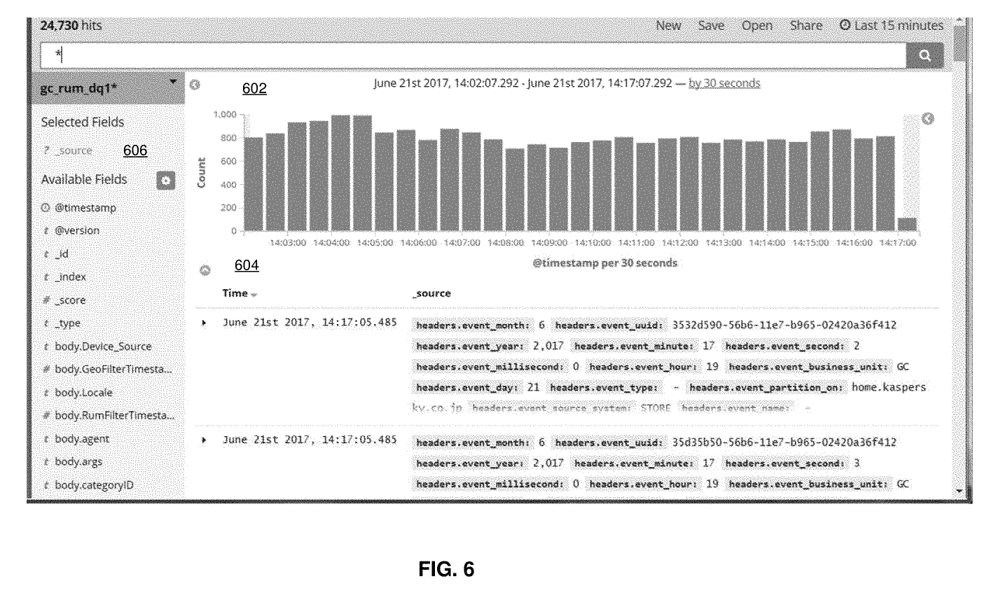

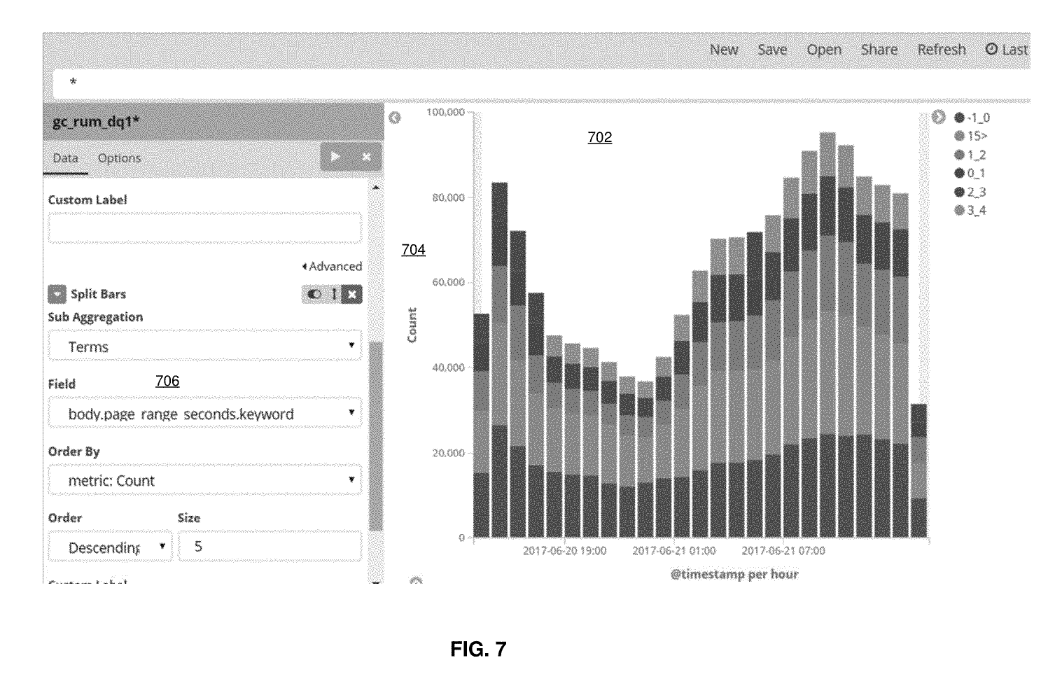

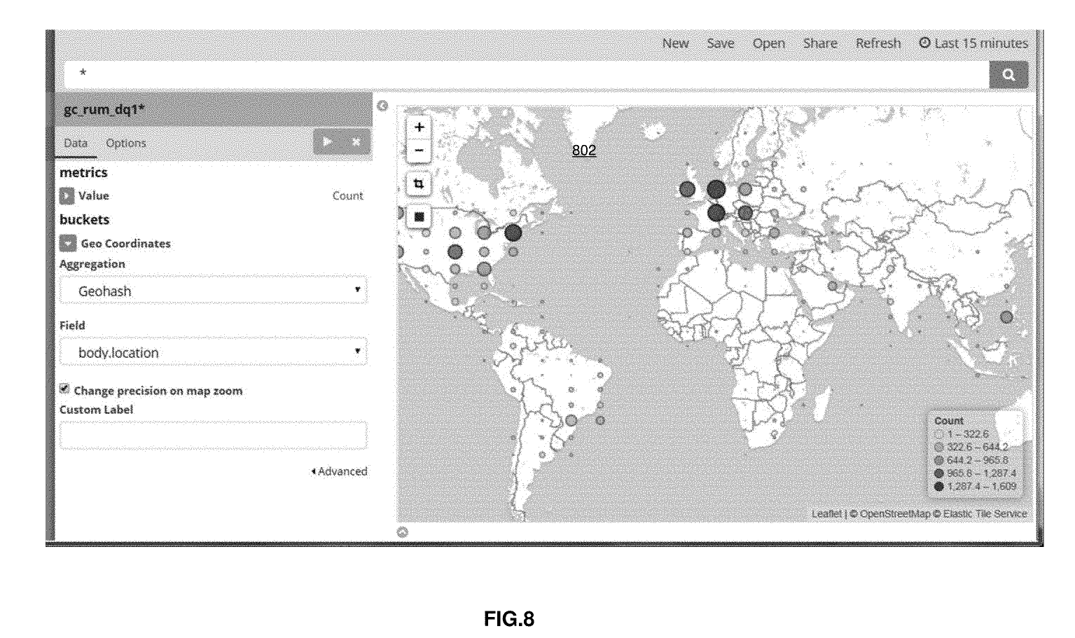

FIG. 6 is a screen shot of an exemplary Kibana 146 screen presenting data in real-time. A bar graph 602 provides a count of page activity (source) for each 30 second period, and the listing below 604 provides additional counts of interest for the same data. The client may choose any available field 606 for presentation and visualization of data. FIG. 7 is a screen shot of a bar graph 702 illustrating page loading range in seconds 704 per count of pages accessed 706. FIG. 8 is a screen shot of a location map showing the number of pages accessed in particular time zones 802.

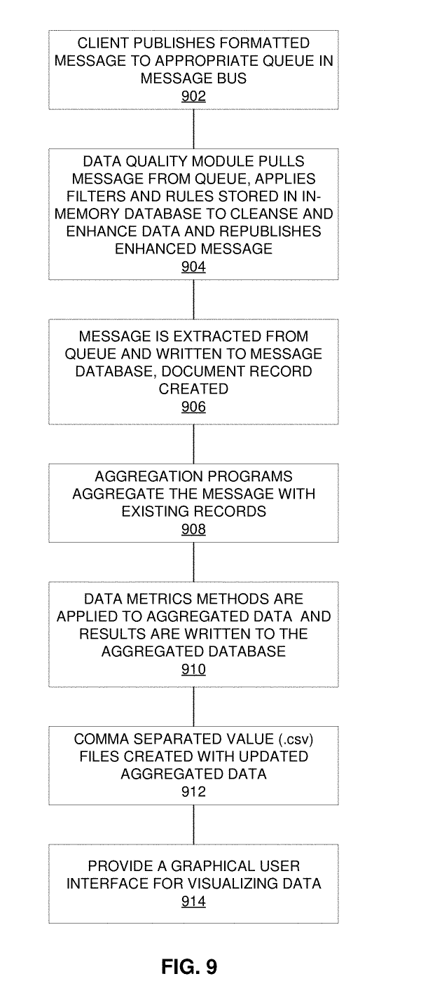

FIG. 9 provides an overview of a preferred embodiment of the method disclosed herein. A client publishes a formatted message to the appropriate queue in a local message bus 902, typically immediately on receiving the transaction on the client system. In a preferred embodiment of the disclosed system and method, the message is formatted in JSON. A “local” message bus refers to the implementation of the disclosed system in a data center processing the transactions. Processing locally may be desired when laws, such as the GDPR (General Data Protection Regulation) in the European Union require that some data provided by internet commerce users not leave the jurisdiction. A data quality module 114, containing input and output definitions and rules for cleansing or enhancing data for downstream metrics, extracts the new message from the queue and applies filters and rules stored in an in-memory database to cleanse and enhance the date, and then republishes the enhanced message to a queue identified by the module 904. The message is extracted from the queue and written to a message database, creating a document record for the message 906. Activity at this database is intensive, without a very high volume of messages being added throughout the day. This database may provide long-term storage for individual messages. Individual message data may be stored in other document-based long-term data storage as well. Aggregate processing programs aggregate the new message with existing message records 908 and run data metrics methods against new aggregated data and write the results to an aggregated data database 910. Comma separated value (.csv) files are created with the updated aggregated data 912 and loaded into a reporting database with a graphical user interface that presents counts, statistics, and graphical representations to interested clients 914. The system uses components are optimized for use with large amounts of streaming data over a highly distributed environment and is able to provide results to the client within real-time parameters.

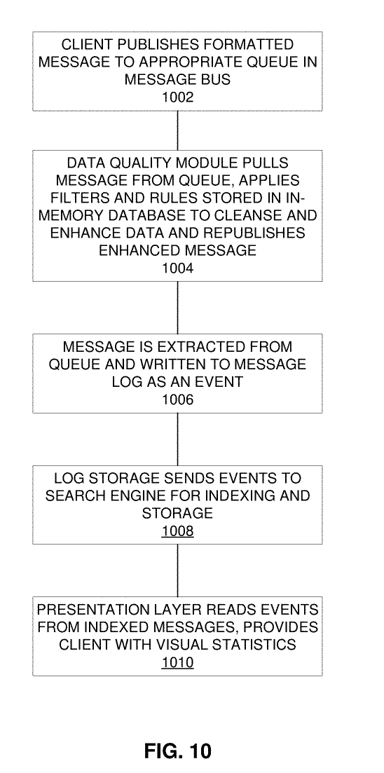

FIG. 10 provides an overview of a preferred embodiment of the method disclosed herein for providing real time business and operational intelligence data to a client. A client publishes a formatted message to the appropriate queue in a local message bus 1002, typically immediately on receiving the transaction on the client system. A data quality module 114, containing input and output definitions and rules for cleansing or enhancing data for downstream metrics, extracts the new message from the queue and applies filters and rules stored in an in-memory database to cleanse and enhance the date, and then republishes the enhanced message to a queue identified by the module 1004. The message is extracted from the queue and written to a message log, creating an event record for the message 1006. The log sends events to a high throughput search engine for indexing and storage 1008. A data presentation layer reads events from the search engine and provides client with visual statistics. The system uses components that are optimized for use with large amounts of streaming data over a highly distributed environment and is able to provide results to the client within real-time parameters.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other updates, combinations, omissions, modifications and substitutions, in addition to those set forth in the above paragraphs, are possible.

The steps and/or actions of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

In one or more embodiments, the functions described may be implemented in hardware, software, firmware, or any combination thereof. If implemented in software, the functions may be stored or transmitted as one or more instructions or code on a computer-readable medium. Non-transitory computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer.

Computer program code for carrying out operations of embodiments of the present invention may be written in an object oriented, scripted or unscripted programming language such as Java, Scala, Perl, Smalltalk, C++, or the like. However, the computer program code for carrying out operations of embodiments of the present invention may also be written in conventional procedural programming languages, such as the “C” programming language or similar programming languages.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block(s).

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A web analytics method comprising:
receiving a plurality of transactions on a client system;
publishing a formatted message in response to each of the plurality of transactions to a message bus;
extracting the plurality of messages from the message bus;
applying filters and rules to the plurality of messages to cleanse and enhance data associated with each of the plurality of messages, and
republishing a plurality of enhanced messages;
writing the plurality of enhanced messages to a message database,
aggregating the plurality of enhanced messages with existing message records to form aggregated data;
running data metrics methods against the aggregated data and write the results to an aggregated data database; and
graphically displaying information at a graphical user interface related to the aggregated data.

2. The web analytics method of claim 1 wherein receiving the plurality of transactions on a client system, the client within real-time parameters, publishing a formatted message in response to each of the plurality of transactions, extracting the plurality of messages from the message bus, and applying filters and rules to the plurality of messages is done in substantially real time.

3. The web analytics method of claim 2 wherein a multiplicity of transactions are received on a daily basis.

4. The web analytics method of claim 1 storing input and output definitions and rules for cleansing or enhancing data for downstream metrics to apply to the plurality of messages.

5. The web analytics method of claim 1 further comprising creating a document record for the plurality of messages when are written to the message database.

6. The web analytics method of claim 1 wherein graphically displaying information includes adding warning indicators to information outside a range of values.

7. The web analytics method of claim 1 wherein graphically displaying information includes adding color indicators to information outside a range of values.

8. The web analytics method of claim 1 further comprising generating a warning message when information is produced outside a range of values.

9. The web analytics method of claim 1 wherein graphics is produced periodically.

10. The web analytics method of claim 1 wherein writing the results to an aggregated database includes formatting the data into comma separated value files.

11. The web analytics method of claim 1 wherein writing the plurality of enhanced messages to a message database creates an event record for the message.

12. The web analytics method of claim 1 wherein writing the plurality of enhanced messages to a message database creates an event record for the message.

13. A non-transitory machine-readable medium providing instructions that, when executed by a machine, cause the machine to perform operations comprising:
receiving a plurality of transactions on a client system;
publishing a formatted message in response to each of the plurality of transactions to a message bus;
extracting the plurality of messages from the message bus;
applying filters and rules to the plurality of messages to cleanse and enhance data associated with each of the plurality of messages, and
republishing a plurality of enhanced messages;
writing the plurality of enhanced messages to a message database,
aggregating the plurality of enhanced messages with existing message records to form aggregated data;
running data metrics methods against the aggregated data and write the results to an aggregated data database; and
graphically displaying information at a graphical user interface related to the aggregated data.

14. The non-transitory machine-readable medium of claim 13 providing instructions that, when executed by a machine, cause the machine to perform operations wherein receiving the plurality of transactions on a client system, the client within real-time parameters, publishing a formatted message in response to each of the plurality of transactions, extracting the plurality of messages from the message bus, and applying filters and rules to the plurality of messages is done in substantially real time.

15. The non-transitory machine-readable medium of claim 13 providing instructions that, when executed by a machine, cause the machine to perform operations wherein storing input and output definitions and rules for cleansing or enhancing data for downstream metrics to apply to the plurality of messages.

16. The non-transitory machine-readable medium of claim 13 providing instructions that, when executed by a machine, cause the machine to perform operations further comprising creating a document record for the plurality of messages when are written to the message database.

17. The non-transitory machine-readable medium of claim 13 providing instructions that, when executed by a machine, cause the machine to perform operations wherein graphically displaying information includes adding warning indicators to information outside a range of values.

18. The non-transitory machine-readable medium of claim 13 providing instructions that, when executed by a machine, cause the machine to perform operations wherein graphically displaying information includes adding color indicators to information outside a range of values

19. The non-transitory machine-readable medium of claim 13 providing instructions that, when executed by a machine, cause the machine to perform operations wherein writing the results to an aggregated database includes formatting the data into comma separated value files.

20. The non-transitory machine-readable medium of claim 13 providing instructions that, when executed by a machine, cause the machine to perform operations wherein writing the plurality of enhanced messages to a message database creates an event record for the message.

21. A web analytics system comprising:
a receiver for receiving a plurality of messages related to a plurality of transactions;
a data quality module that includes memory for storing definitions and rules that is applied to the plurality of messages, the data quality module applying the definitions and rules to the plurality of messages to produce a plurality of enhanced messages, the plurality of enhanced messages placed in at least one queue;
an event message log that removes the enhanced messages from the at least one queue and logs the plurality of enhanced messages to create a plurality of event records for the plurality of enhanced messages;
a search engine for indexing and storing the plurality of event messages in the event message log;
a statistics element that applies statistics to the plurality of event messages; and
a data presentation device that provides visual information related to results of statistical analysis to the plurality of event messages.

22. The web analytics system of claim 21 further comprising an analytics engine that determines which of the statistics is relevant and produces indicators when a relevant statistic is outside a selected range.

23. The web analytics system of claim 21 wherein the receiver further comprises a storage system that includes:
a long-term storage portion; and
a short-term storage portion.

24. The web analytics system of claim 21 wherein the data quality module includes a personal data stripper for stripping personal information from the plurality of enhanced messages.

25. The web analytics system of claim 21 further comprising a data aggregator for calculating metrics on the plurality of enhanced messages.

26. The web analytics system of claim 21 wherein the data aggregator operates on data stored in the data aggregator over a specified time.

27. The web analytics system of claim 21 wherein the data aggregator includes a dashboard for part of a payment processing system.
